(19) United States
(12) Patent Application Publication
(10) Pub. No.: US 2007/0009397 A1
(43) Pub. Date: Jan. 11, 2007

(54) Arrangement for Testing Pharmaceutical Substances

(76) Inventor: Karl-Heinz HEHL, Giessen (DE)

Correspondence Address: DENNISON, SCHULTZ & MACDONALD, 1727 KING STREET, SUITE 105, ALEXANDRIA, VA, 22314, US

(21) Appl. No.: 11/428,553

(22) Filed: Jul. 4, 2006

(30) Foreign Application Priority Data
Jul. 4, 2005 (DE) 202005010588.0

(51) Int. Cl. B01L 9/00

(52) U.S. Cl. 422/104

(57) ABSTRACT

An arrangement which may be used for testing pharmaceutical or cosmetic substances, which are sealed in a testing room in a cabinet (100), with at least one elongated radiation source (14) such as a fluorescent tube arranged in the testing room, as well as at least one receptacle (12) such as a storage place for the samples. A mechanical filter is arranged between the radiation source (14) and the at least one receptacle (12), the mechanical filter extending along the radiation source and homogenizing light intensity impacting on the receptacle.

### BACKGROUND OF THE INVENTION

The invention deals with an arrangement for testing samples such as pharmaceutical or cosmetic substances comprising a cabinet enclosing a testing room with at least one elongated radiation source such as a fluorescent tube arranged in the testing room, as well as at least one receptacle, such as a storage place for the samples.

Corresponding arrangements referred to as pharmaceutical test cabinets are needed to make statements on the pharmaceutical substances during storage. In such cabinets, not only are temperature and climate important, but illumination also is particularly important. To measure the influence of light, it is known to arrange samples in a cabinet in compartments that contain daylight and UV lamps. Conclusions can be drawn thereby about the photo stability.

With test cabinets in which elongated radiation cells such as fluorescent tubes are arranged parallel to the storage space and floor space of the samples, respectively, to measure the light influence on the samples, there is a disadvantage in that the samples need to be rearranged so that the samples are exposed to equal light intensities during the entire test period; corresponding elongated light sources, particularly fluorescent tubes, have the property that the surface presents uneven irradiation along its length, i.e. the intensity is at a maximum is in the middle of the tube and becomes weaker towards the outside.

In the prior art, many means are known for influencing the radiation of light sources such as UV radiators or fluorescent lamps. According to DE-U-18 04 140, adjustable plastic filters are provided to achieve a desired radiation distribution. For changing the intensity distribution separate controls are provided. The radiation can also be influenced by a heat protection filter (DE-B-19 54 097), diffusing panels (DE-A-197 14 234), glass filters (DE-A-43 30 759), optical filters (JP-A-03-075 542) or reflectors (DE-A-31 27 707). According to EP-A-1 528 388, UV illumination emission diodes are used to achieve desired spectral and spatial conditions in the artificial weathering of samples. According to DE-U-299 19 438, UV radiation is directed to a sample to be tested by way of high-reflecting reflectors for achieving the desired effect and heating of the sample.

### SUMMARY OF THE INVENTION

It is an object of the invention to further develop an arrangement of the type mentioned hereinabove, such that the radiation impacting on the samples is homogenized, i.e. that the light intensity is homogenized over the entire storage space and floor space of the samples, respectively, so that a re-arrangement of the samples is not required.

In accordance with the invention, the problem is essentially solved by arranging a mechanical filter between at least one radiation source and at least one receptacle, the filter extending along the radiation source and homogenizing light intensity impacting on the receptacle. This mechanical filter, in particular, is a perforated plate or a slotted plate. It is also possible that the mechanical filter may be composed of several elements aligned with one another. Alternatively, a straight filter (straight plate) with correspondingly dimensioned bores and slots can be used.

Preferably, the invention provides that the mechanical filter relative to the receptacle presents in cross section a concave or channel-like course of geometry. The mechanical filter in its cross section can present an arc-shaped or open trapezoidal course.

It is provided in particular that several elongated radiation sources are arranged in the testing room extending in parallel to each other and forming a luminous field, and that the mechanical filter has a middle planar section that extends in parallel to the luminous field, as well as two planar outer sections originating from the middle section and angled towards the receptacle.

The mechanical filter consists particularly of a sheet metal material that is a straight, bent or folded metal sheet, which has corresponding openings to enable the creation of the desired homogenized intensity distribution across the entire sample receiving surface.

According to the invention, the maximum radiation is reduced in the middle of the radiation source and a substantially homogenous radiation of the sample is achieved.

### BRIEF DESCRIPTION OF THE DRAWINGS

Further details, advantages and features of the invention result not only from the claims and from the characteristic features they include, alone and/or in combination, but also from the following description of an embodiment shown in the drawings, in which:

FIG. 1 is a principle representation of a testing room of a pharmaceutical test cabinet;

FIG. 2 is a top view of a mechanical filter shown in FIG. 1 for the intensity homogenizing; and

FIG. 3 is a principle representation of a test cabinet.

### DESCRIPTION OF THE PREFERRED EMBODIMENTS

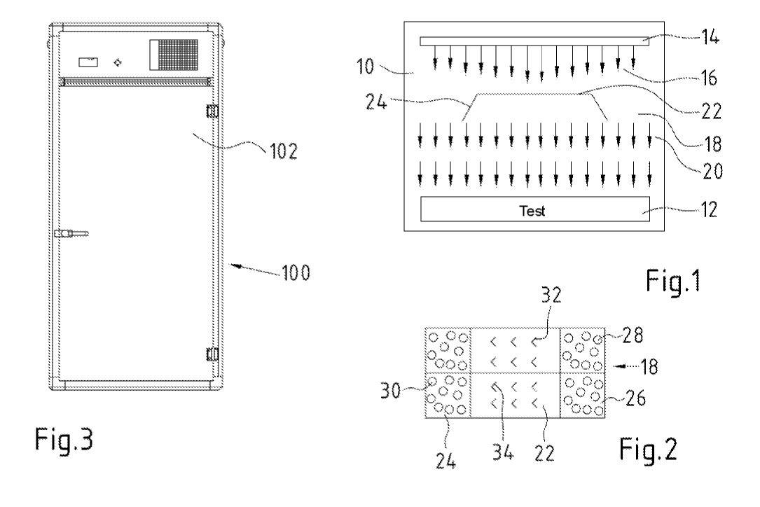

FIG. 1 shows a testing room 10 of the pharmaceutical test cabinet 100 shown in FIG. 3, in which samples arranged in a receptacle and on a storage place 12, respectively, are to be tested for photo stability. The testing room 10 can be accessed by way of a door 102 locking the test cabinet 100.

Above the receptacle 12, several radiation sources 14 are preferably placed, to form a luminous field. These radiation sources are particularly fluorescent tubes, some of which emit daylight and others UV light. For this purpose, different fluorescent tubes can be arranged in the desired sequence in the ceiling area of the testing room 10. The placement can be mixed (daylight and UV light) or separated (on each level only daylight or only UV light).

Corresponding elongated radiation sources 14, such as fluorescent tubes, have the property that along the radiating surface, i.e. along their longitudinal axis, their radiation is uneven, such that a maximum appears in the middle of the radiation source 14. This is shown by arrows 16 of different lengths, which originate from the radiation sources 14.

In order to achieve an even light intensity distribution for the samples along the receptacle 12 despite the above problem, a mechanical filter 18 is placed between the receptacle 12 and the radiation source, i.e. the radiation sources 14, which particularly is a bent and perforated sheet metal plate. This mechanical filter enables homogenizing of the light intensity along the receptacle 12, which is symbolized by arrows 20 of same length.

Plastics can also be used as material for the filter 18.

In the embodiment shown, the mechanical filter 18 is a channel-shaped element open relative to the receptacle 12 and formed of a middle section 22 running in parallel to the radiation sources 14 and of outer sections 24 and 26 angled towards the receptacle 12. Other geometries such as a bent shape geometry that shows a concave profile with regard to the receptacle 12 are likewise possible. Alternatively, the plate can have a straight geometry with different perforations or grooves, the plate running on a single level and being perforated and slotted, respectively, in correspondence with the desired filtering action. Also, it is possible that the sections 22, 24, 26 have, as shown in FIG. 2, perforated areas (holes 28, 30) and/or slots 32, 34 to achieve the desired homogenized light intensity across the entire storage place of the samples 12. Aligning separate sections 22, 24 and 26 is also possible to form the mechanical filter 18.

The teaching according to the invention results in the advantage that in photo stability testing of pharmaceutical substances, the substances are subjected to the required even intensity above the storage space of the samples so that reproducible results are achievable without the need for rearrangement of the samples or for complicated optical aids.

Although a single mechanical filter is shown in the embodiment to obtain the desired homogenizing of the intensity, it is equally possible to arrange several filters side by side and/or on top of each other. The mechanical filter can have openings in the form of holes or slots. Likewise, closed plates arranged side by side and spaced from each other can be used. Instead of sheet metal materials, other suitable materials also can be used to form the mechanical filter.

What is claimed is:

1. An arrangement for testing samples such as pharmaceutical or cosmetic substances comprising a cabinet (100) enclosing a testing room (10) with at least one elongated radiation source (14) such as a fluorescent tube arranged in the testing room, as well as at least one receptacle (12) such as a storage place for the samples,
wherein a mechanical filter is arranged between the radiation source (14) and the at least one receptacle (12), the mechanical filter extending along the radiation source and homogenizing light intensity impacting on the receptacle.

2. Arrangement according to claim 1, wherein the mechanical filter (18) is a slotted or perforated plate.

3. Arrangement according to claim 1, wherein the mechanical filter (18) relative to the receptacle (12) shows a concave and channel-shaped geometry, respectively, or a straight geometry.

4. Arrangement according to claim 1, wherein the mechanical filter (18) in cross section has a bent or open trapezoidal geometry.

5. Arrangement according to claim 1, wherein, in the testing room (10), several elongated radiation sources (14) running parallel to each other and forming a luminous field are arranged, and the mechanical filter (18) comprises a middle planar section (22) extending in parallel to the luminous field, as well as two outer sections (24, 26) being bent towards the receptacle (12).

6. Arrangement according to claim 1, wherein the mechanical filter (18) comprises a plurality of aligned elements.

7. Arrangement according to claim 1, wherein the mechanical filter (18) comprises sheet metal material.

8. Arrangement according to claim 1, wherein the mechanical filter (18) is a bent or folded sheet metal plate.

9. Arrangement according to claim 1, wherein the mechanical filter (18) is a plastic part.

10. Arrangement according to claim 1, wherein the mechanical filter (18) shows a geometry following in cross section a straight line.

11. Arrangement according to claim 1, wherein the mechanical filter (18) defines a planar surface.
